(19) United States
(12) Patent Application Publication
(10) Pub. No.: US 2004/0093967 A1
(43) Pub. Date: May 20, 2004

(54) Starter for internal combustion engine

(75) Inventors: Tsutomu Shiga, Nukata-gun (JP); Masami Niimi, Handa-shi (JP); Mitsuhiro Murata, Niwa-gun (JP); Masanori Ohmi, Anjo-shi (JP); Yasuyuki Wakahara, Kariya-shi (JP)

Correspondence Address: OLIFF & BERRIDGE, PLC, P.O. BOX 19928, ALEXANDRIA, VA, 22320, US

(73) Assignee: DENSO CORPORATION, KARIYA-CITY (JP)

(21) Appl. No.: 10/703,499

(22) Filed: Nov. 10, 2003

(30) Foreign Application Priority Data
Jun. 5, 2003 (JP) 2003-161049
Nov. 19, 2002 (JP) 2002-335229

(51) Int. Cl. F02N 1/00

(52) U.S. Cl. 74/7 E

(57) ABSTRACT

The present invention relates to a starter for an engine, capable of driving the engine at a high torque at the beginning of the starting and of driving it in a high-rotation condition at the end of the starting. An inner circumferential tapered portion of a movable cam plate is pressed against an outer circumferential portion of an outer cam of a clutch so that the outer cam and an internal gear are integrated to rotate at the same speed. Thus, on the epicycle reduction principle, in an epicycle reduction gear device, a sun gear, a planetary gear and an arm portion enter an identical-rotation condition, that is, a reduction ratio 1 condition. Moreover, an outer circumferential tapered portion of the movable cam plate is pressed against a tapered portion of a housing so that the internal gear is placed into a fixed, non-rotatable condition, thereby providing an ordinary epicycle reduction to produce a high reduction ratio.

### BACKGROUND OF THE INVENTION

1) Field of the Invention

The present invention relates to a starter serving as a starting apparatus for starting an internal combustion engine, and more particularly to an output characteristic of the starter.

2) Description of the Related Art

In the recent years, to cope with the environmental problems, requirements exist in that a starter becomes small in size but high in torque and rotation. In general, in starting an internal combustion engine, a need for a high torque exists at an initial stage, but a need for a low torque exists after the first explosive combustion. For this reason, basically, the series type has been employed so far. However, for the purpose of size reduction, the trend in the starter has been toward a higher internal reduction ratio for a higher torque. This signifies that there is a tendency that difficulty is experienced in easily acquiring the rotation after the completion of the combustion, except the first explosive combustion. Recently, the magnet type (so-called the shunt type) has been employed from the viewpoint of the cost-down and size reduction, which makes it increasingly difficult to enhance the speed of rotation.

Accordingly, the optimum reduction ratio becomes unobtainable in both the high-temperature and low-temperature conditions of an engine as shown in FIG. 16. FIG. 16 is a graphic illustration of torque-rotation speed characteristic curves at various reduction ratios in the case of a 2-kW starter. For the actual countermeasures against this, a plurality of reduction ratios are arranged, which leads to the difficulty of standardization. Recently, a requirement also exists for enhancing the speed of rotation of a starter after the engine ignition (that is, an overrunning state of the starter). However, this actually requires its larger body conformation. For example, a 1.4-kW starter is acceptable only for the starting, but the compatibility between the torque and the rotation is accomplished through the use of a 2-kW starter. This is remote from the reduction in size and weight.

One approach to solve this problem is to switch the internal reduction ratio of the starter in a multistage fashion for accomplishing the compatibility between a high torque and a high rotation. Japanese Patent Laid-Open No. 2001-153008 discloses a two-stage reduction technique using a solenoid, and Japanese Patent Laid-Open No. SHO 63-195383 discloses a variable-speed technique using gear wheels. However, these techniques cause a more complicated reduction mechanism and a larger body conformation.

That is, the former technique requires a large solenoid unit and special control on a temperature sensor and other components for the operation thereof, and the latter technique requires a reduction apparatus larger in body conformation than the motor for the variable-speed arrangement. Therefore, these techniques become not only larger in body conformation but also more complicated and even higher in manufacturing cost. In consequence, the employment of a standard starter higher one or two grades than usual becomes more advantageous in size and cost. Such a variable-speed technique is remote from the practical use. Moreover, Japanese Patent Laid-Open Nos. 2001-295865 and HEI 10-115274 also disclose such types of starters.

### SUMMARY OF THE INVENTION

The present invention has been developed with a view to eliminating these problems, and it is therefore an object of the invention to provide a starter capable of realizing variable reduction through the use of an internal gear type planetary reduction mechanism usually used for starters without requiring a complicated control mechanism for the variable reduction.

That is, an ordinary planetary reduction mechanism is designed to provide a predetermined reduction ratio by fixing an internal gear, and the rotations of the internal gear is directly outputted without reduction when the internal gear is released from the fixed state to result in the same speed of rotation as, for example, that of a planetary gear shaft (that is, an arm portion). Moreover, attention was paid to the fact that an intermediate reduction ratio is attainable when the internal gear and the arm portion are brought into sliding contact with each other.

For example, in the case of a 1.8-kW starter, when the rotation of the arm portion (which is the same as the rotation of the pinion) is between 0 to approximately 1000 rpm as shown in FIG. 2, the internal gear is placed into a fixed state, and when it exceeds approximately 8000 rpm, the arm portion and the internal portion are set at the same speed of rotation, while they are set at an intermediate value between 1000 to 8000 rpm. Thus, as shown in FIG. 1, the reduction ratio is set at a high value (7.9) in a range between points A and B (when the speed of rotation is low), and no reduction (reduction ratio 1) is made in a range between the points C and D (at high speeds of rotation), while the reduction ratio is gradually decreased from 7.9 to 1 in a range between the points B and C (at intermediate values). This enables easily achieving a maximum torque and rotation. The employment of this mechanism can realize a starter small in size and low in cost.

According to a first aspect of the present invention, a starter employs an epicycle reduction gear device and the rotation of one of elements constituting a planetary gear train of the epicycle reduction gear device is switched between a fixed condition and a released condition, thereby enabling changing the reduction ratio in a plural-stage fashion or in a variable-speed fashion at a simple construction without changing the dimension of the starter and driving an internal combustion engine at a high torque at the beginning of starting and at a high speed of rotation at the end of starting, which achieves a starter friendly to the environment without an increase in cost.

According to a second aspect of the present invention, the planetary gear train includes an internal gear pair and the reduction ratio is changed by varying the rotation of an internal gear. Thus, the variable reduction is attainable more easily without an increase in cost.

According to a third aspect of the present invention, a variation of rotation of the element (for example, the internal gear) is made on the basis of information on at least one of a torque of a motor and a speed of rotation thereof. This varies the reduction ratio on the basis of the internal information (characteristic) of the starter. Therefore, there is no need to consider external influences such as the internal combustion engine, the difference among batteries, which can eliminate the need for special sensors, thus producing a stable reduction ration variation at a low cost.

According to a fourth aspect of the present invention, during cranking, the internal gear is fixed at the first explosive combustion of the internal combustion engine to maintain a high reduction ration condition, and the speed of rotation of the internal gear is then made equal or substantially equal to the speed of rotation of an armature or a planetary gear shaft to produce a reduction ratio 1 condition or a low reduction ratio condition before starting the engine, thereby enabling the starting fit for an engine load.

According to a fifth aspect of the present invention, the epicycle reduction gear device is composed of a sun gear fitted over an armature shaft of the motor, a planetary gear engaging with the sun gear, the internal gear and a shaft of the planetary gear, with the shaft of the planetary gear being connected through a clutch to the pinion, and the internal gear is fixed at the beginning of the cranking and the speed of rotation of the internal gear is then set at the same value as that of the armature or the planetary gear shaft to switch the reduction ratio in two stages. This enables a simple construction and starting the engine in a condition better in characteristic than the conventional fixed reduction ratio.

According to a sixth aspect of the present invention, the epicycle reduction gear device is composed of a sun gear fitted over an armature shaft of the motor, a planetary gear engaging with the sun gear, the internal gear and a shaft of the planetary gear, with the shaft of the planetary gear being connected through a clutch to the pinion, and the internal gear is fixed at the beginning of the cranking and the speed of rotation of the internal gear is finally set at the same value as that of the armature or the planetary gear shaft and the internal gear is brought into sliding contact with the armature or the planetary gear shaft in a condition between the beginning of the cranking and the final value to gradually vary the speed of rotation of the internal gear for varying the reduction ratio in a variable-speed fashion. This allows the internal gear unit low in torque reaction to make the sliding contact in a moment, thus reducing the torque loss and providing an ideal characteristic needed in starting the engine with a simple construction.

According to a seventh aspect of the present invention, a low reduction ratio condition is realizable only by bringing the internal gear into contact with the clutch. This does not require a special space, and lowers the cost. As the clutch, a general overrunning clutch is acceptable.

According to an eighth aspect of the present invention, the internal gear is released from the fixed state on the basis of information such as a speed of rotation of a motor, a torque thereof, a current thereof or an output thereof at a maximum output of the motor to make the switching to a low reduction ratio. Thus, the maximum TN characteristic at that rated power is obtainable. The TN characteristic signifies a torque-rotation speed characteristic.

According to a ninth aspect of the present invention, the fixing and releasing of the internal gear are made through a member which operates while sensing a reaction force of the motor torque at the internal gear unit. This enables the control thereof to be implemented by a torque (force) univocally determined by a current without being affected by the difference among batteries, thus facilitating the switching timing of the reduction ratio.

According to a tenth aspect of the present invention, the epicycle reduction gear device is composed of a sun gear fitted over an armature shaft of the motor, a planetary gear engaging with the sun gear, the internal gear and a shaft of the planetary gear, with the shaft of the planetary gear being connected through a clutch to the pinion, and the internal gear is fixed directly or indirectly to a body of the starter at the beginning of the cranking to place the reduction ratio in a high condition and the internal gear is brought directly or indirectly into contact with the clutch at the latter half of the cranking so that the speed of rotation of the internal gear is set to be substantially equal to that of the armature (same as the clutch) to place the reduction ratio at 1 or in a low reduction ratio condition, with the switching of the reduction ratio being made by sensing a torque of the internal gear unit. This enables a high reduction condition and a low reduction condition without using many special parts, that is, through the use of most of the existing parts, thereby suppressing an increase in cost.

According to an eleventh aspect of the present invention, the fixing and releasing of the internal gear are made through the use of a cam mechanism including a fixed cam plate, a movable cam plate and a ball, with one being used in common (sharing) as the internal gear unit, which provides a speed-change mechanism small in size and low in cost.

According to a twelfth aspect of the present invention, to bring the movable cam plate closer to the fixed cam plate side or to isolate it therefrom, the fixing and releasing of the internal gear are made according to the magnitude of a combination of a reaction force of a torque of the motor at the internal gear unit and a set load of an elastic member. Accordingly, a set value for the switching therebetween can easily be made only by changing the load of the elastic member, which easily provides a predetermined characteristic and suppresses an increase in cost.

According to a thirteenth aspect of the present invention, the set load of the elastic member is set at a force equivalent to a torque corresponding to a maximum output current of the starter. Therefore, a maximum TN (torque, speed of rotation) characteristic at the rated output is obtainable without an increase in cost.

### BRIEF DESCRIPTION OF THE DRAWINGS

Other objects and features of the present invention will become more readily apparent from the following detailed description of the preferred embodiments taken in conjunction with the accompanying drawings in which:

FIG. 1 is an illustration of an example of a torque-rotation speed characteristic of a starter according to a first embodiment of the present invention;

FIG. 2 is an illustration of an example of the relationship between the speed of rotation of an internal gear and the speed of rotation of a pinion unit (same as an arm portion or a planetary gear shaft) in the starter according to the first embodiment;

FIG. 3 is a cross-sectional view showing the starter according to the first embodiment in a stationary state;

FIG. 4 is a cross-sectional view showing the starter according to the first embodiment in an engine driving state (high reduction ratio condition);

FIG. 5 is a cross-sectional view showing the starter according to the first embodiment in an engine driving state (low reduction ratio condition);

FIG. 6 is a cross-sectional view showing a cam mechanism of the starter according to the first embodiment in a low reduction ration condition;

FIG. 7 is a cross-sectional view showing a cam mechanism of the starter according to the first embodiment in a high reduction ration condition;

FIG. 8 is a circumferential cross-sectional view around the vicinity of a ball unit shown in FIG. 6;

FIG. 9 is a circumferential cross-sectional view around the vicinity of the ball unit shown in FIG. 7;

FIG. 10 is a cross-sectional view showing a cylinder unit for use in the starter according to the embodiment;

FIG. 11 is a front elevational view showing a movable cam plate for use in the starter according to the first embodiment;

FIG. 12 is a cross-sectional view showing a movable cam plate according to a second embodiment of the present invention;

FIG. 13 is a cross-sectional view showing a starter according to a third embodiment of the present invention;

FIG. 14 is a cross-sectional view showing a starter according to a fourth embodiment of the present invention;

FIG. 15 is a characteristic illustration useful for explaining the effects of the starters according to the embodiments of the present invention; and

FIG. 16 is an illustration of a torque-rotation speed characteristic for explaining the relationship with an engine load in a conventional starter.

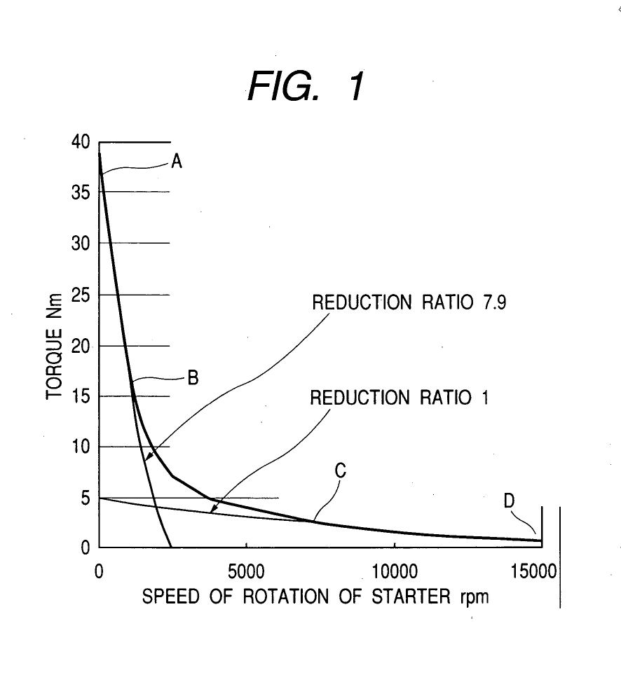

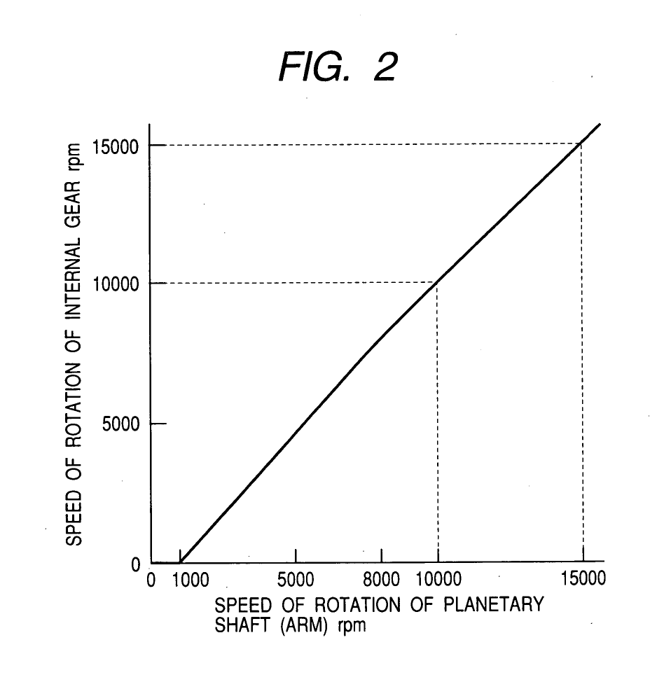

### DESCRIPTION OF THE PREFERRED EMBODIMENTS

(First Embodiment)

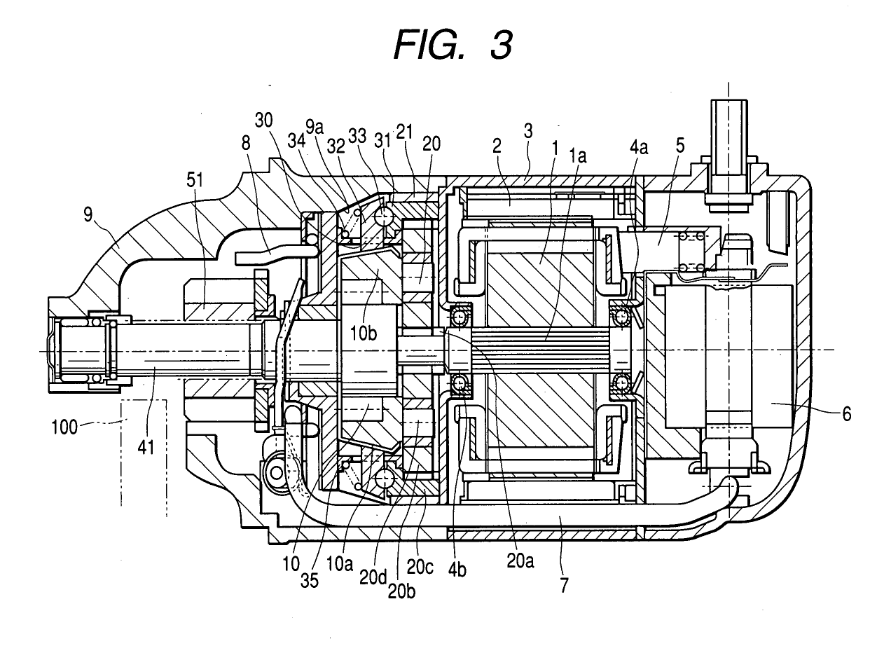

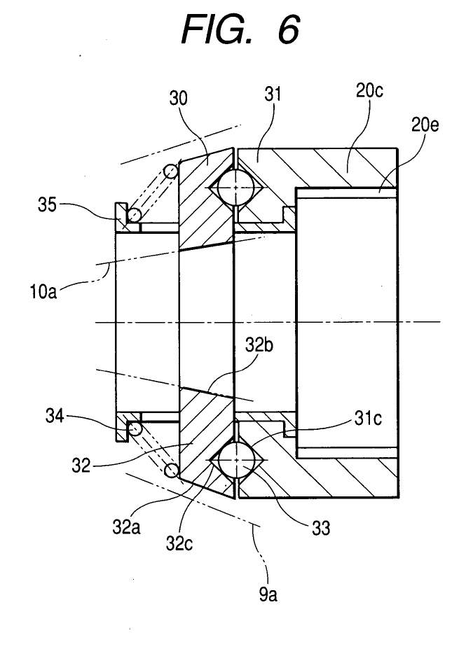

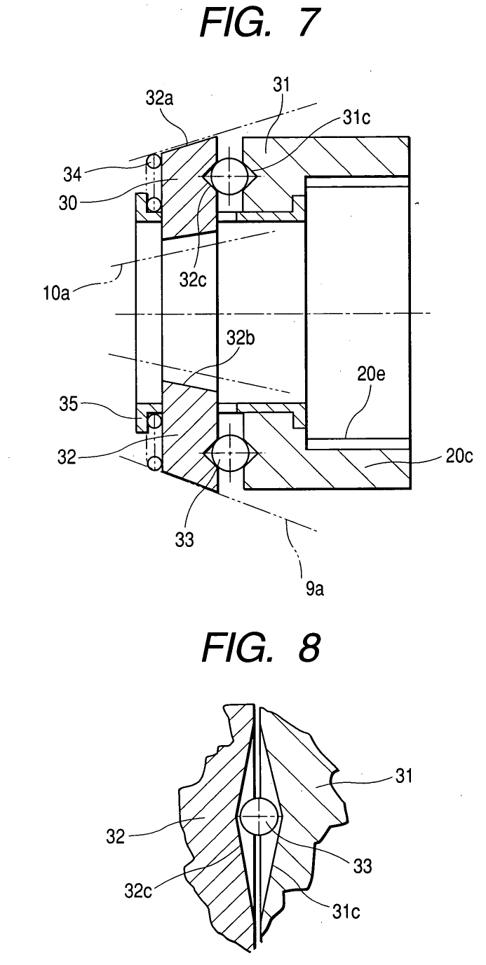

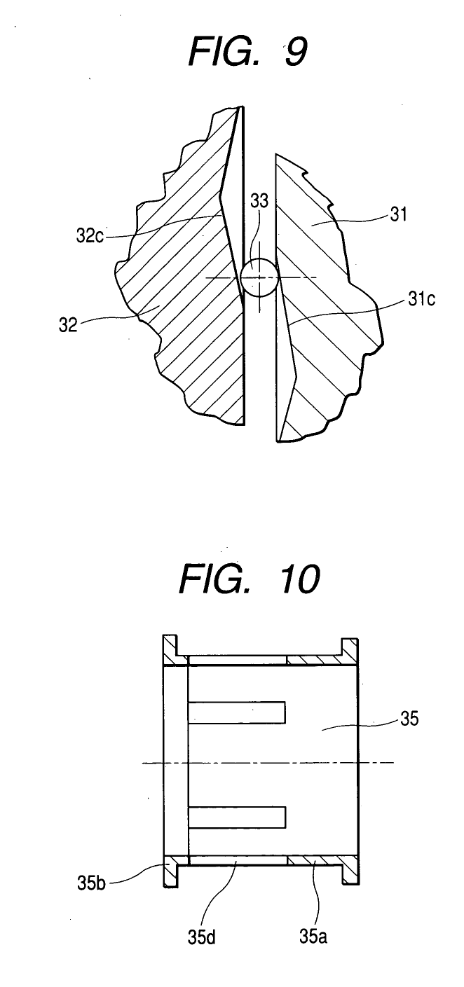

A starter according to a first embodiment of the present invention will be described hereinbelow with reference to FIGS. 3 to 11.

In the illustrations, designated at reference numeral 20 is an internal gear type epicycle reduction gear mechanism using an internal gear and functioning as an epicycle reduction gear device, comprising a sun gear 20a, a planetary gear 20b, a gear portion 20e of an internal gear 20c, and a planetary gear shaft 20d. The sun gear 20a is coupled to a shaft 1a of an armature 1, and the planetary gear shaft 20d is coupled to an outer cam 10b of an overrunning clutch 10. Thus, in consequence, the outer cam 10b of the clutch 10 acts as an arm portion of the epicycle reduction gear mechanism.

A cam mechanism, designated at reference numeral 30, includes a fixed cam plate 31 and a movable cam plate 32 paired and coaxially disposed in opposed relation to each other so that one is unmovable in axial directions and the other is movable in the axial directions, and having a proper number of paired cam grooves 31c and 32c made in their opposed surfaces, balls 33 each accommodated in the pair of cam grooves 31c and 32c of both the cam plates 31 and 32, and an elastic member 34 made to elastically bias (urge) the movable cam plate 32 toward the fixed cam plate 31 side. In this embodiment, four cam grooves 31c are made in the fixed cam plate 31 and, likewise, four cam grooves 32c are made in the movable cam plate 32. In consequence, four pairs of cam grooves are disposed between both the cam plates 31 and 32. In this embodiment, one ball 33 is placed for each pair of cam grooves. In consequence, the cam mechanism 30 includes four balls 33. Connection portions 32d of the movable cam plate 32 are inserted into grooves 35d of a cylinder unit 35 so that the movable cam plate 32 is movable in axial directions but unmovable in circumferential directions. In this embodiment, the grooves 35d are six in number. However, the number of grooves 35d is not limited to this. Members 35a and 35b of the cylinder unit 35 are first produced separately from each other and integrated with each other in an appropriate manner after the connection portions 32d and the grooves 35d are engaged with each other. The fixed cam plate 31, the movable cam plate 32, the balls and the elastic member 34 are integrally fixed by means of flange portions formed at both end portions of the cylinder unit 35, thereby constituting the cam mechanism 30 as a whole.

In the aforesaid one cam grooves 31c or 32c, a slope is formed so that the depth decreases in at least one of circumferential directions, while in the other cam grooves, a slope is formed so that the depth decreases in at least the other circumferential direction, and the depths at the deepest portions of both the cam grooves 31c and 32c are set to be smaller in dimension than the radius of the ball 33 and the depths at the shallowest portions of both the cam grooves 31c and 32c are set to prevent the ball 33 from breaking free therefrom. Moreover, the dimensions of these cam grooves are made such that the movable cam plate 32 is brought close to the fixed cam plate 31 side when the ball 33 is placed at the deepest positions of both the cam grooves 31c and 32c due to the relative rotation of both the cam plates 31 and 32 while the movable cam plate 32 is isolated from the fixed cam plate 31 side when the ball 33 is located at the shallowest positions of both the cam grooves 31c and 32c due to the relative rotation of both the cam plates 31 and 32. In this embodiment, the cam grooves 31c and 32c are defined by slopes made such that the depths decrease toward both circumferential sides. As shown in FIG. 11, the cam grooves 31c and 32c are disposed at an equal interval, and the radial width of each of the cam grooves 31c and 32c becomes at a maximum at the deepest portion and decreases gradually as the depth thereof decreases in the circumferential direction.

The details of the cam mechanism are disclosed in Japanese Patent Laid-Open No. 2001-295865, and a detailed description will be omitted for brevity.

The fixed cam plate 31 and the cylinder unit 35 are fixedly secured to each other in a proper manner, for example, in a manner such that the cylinder unit 35 is inserted into an inner circumferential portion of the fixed cam plate 31 under pressure. Moreover, the fixed cam plate 31 forms a side surface portion of the internal gear 20c. Still moreover, the internal gear 20c is supported through a bearing 21 by the starter body. In this connection, in a case in which the planetary gears 20b are three or more in number, the centering becomes feasible and, hence, the bearing 21 is omissible. A force of a switch 6 moves a pinion 51 toward a ring gear 100 side on an output shaft 41 with a rotation limiting member 8 being moved through a connection bar 7.

A description will be given hereinbelow of an operation of the starter according to the present invention.

A current from a battery (not shown) passes through a brush 5 and is fed to the armature 1 supported by bearings 4a and 4b so that the armature 1, together with field poles 2 of a yoke 3, generates a rotational force. In FIGS. 3, 6 and 8, since the torque to be generated by the motor is low in the stage until the pinion 51 engages with the ring gear 100, the reaction force of the internal gear 20c is low, and the movable cam plate 32 is pressed or biased toward the balls 33 and the fixed cam plate 31 by a force of the elastic member 34. Accordingly, an inner circumferential tapered portion 32b of the movable cam plate 32 is pressed against an outer circumferential portion 10a of the outer cam 10b of the clutch 10, and the outer cam 10b and the internal gear 20c are associated with each other as one and rotate at the same speed. This causes the sun gear 20a, the planetary gear 20b and the arm portion to be placed into a same speed-of-rotation condition, in other words, a reduction ratio 1 condition, on the principle of the epicycle reduction.

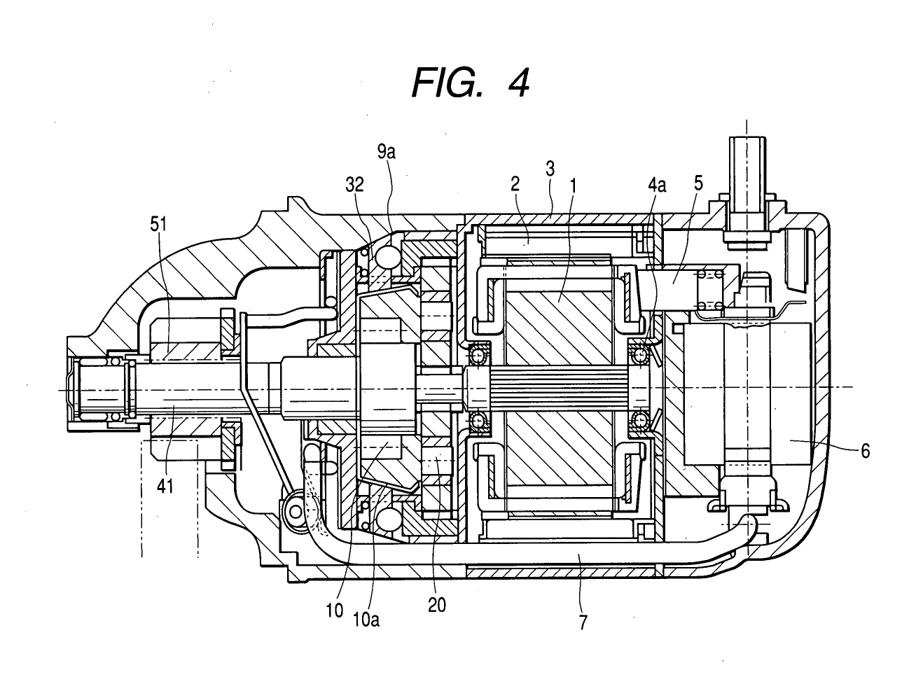

Furthermore, referring to FIGS. 4, 7 and 9, when the pinion 51 engages with the ring gear 100 to start to drive the engine, a torque equivalent to the lock occurs in the motor and, hence, the reaction force of the internal gear 20c becomes large to exceed the force of the elastic member 34 so that the movable cam plate 32 is separated from the fixed cam plate 31 due to the effects of the balls 33 and the cam grooves 31c and 32c. As a result, the outer circumferential portion 10a of the outer cam 10b and the inner circumferential tapered portion 32b of the movable cam plate 32 are separated from each other and, conversely, an outer circumferential tapered portion 32a of the movable cam plate 32 is brought into contact with a tapered portion 9a of a housing 9 under pressure so that the internal gear 20c is placed into a fixed state to be inhibited to rotate. In consequence, they fall into the same epicycle reduction state as general to provide a high reduction ratio.

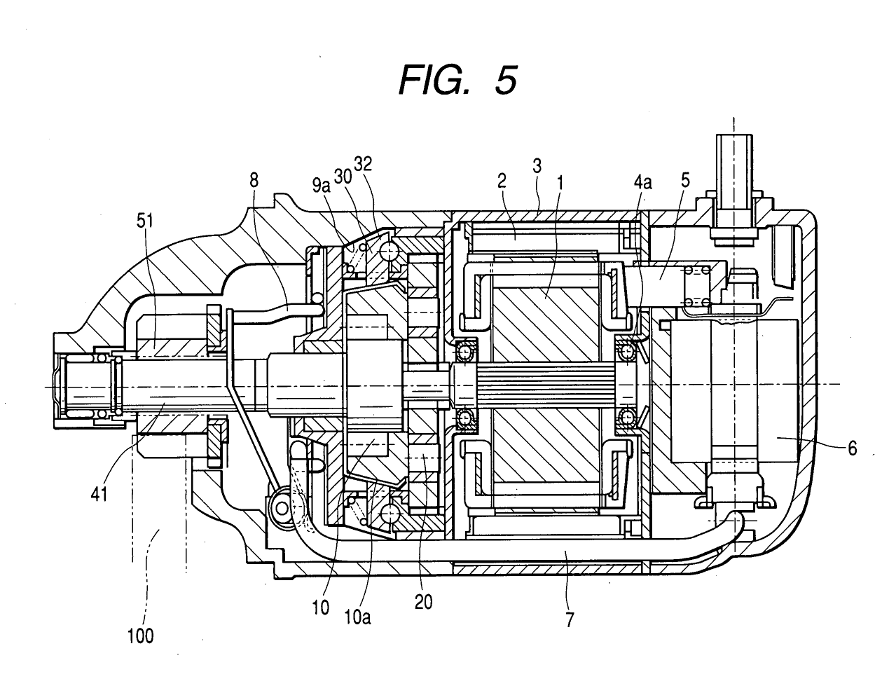

In this state, after the first explosive combustion, when the rotation of the engine becomes higher and the load becomes lower and, hence, the torque of the motor decreases and the reaction force of the internal gear 20c decreases so that the force of the elastic member 34 exceeds it (see FIGS. 5, 6 and 8), the movable cam plate 32 is again moved toward the fixed cam plate 31 side and the driving is conducted in the reduction ratio 1 condition. Naturally, the switching of the reduction ratio can be made at an arbitrary torque (current value) depending on a set value of the load of the elastic member 34. The other operation is described in Japanese Patent Laid-Open No. HEI 10-115274, and the description thereof will be omitted form brevity.

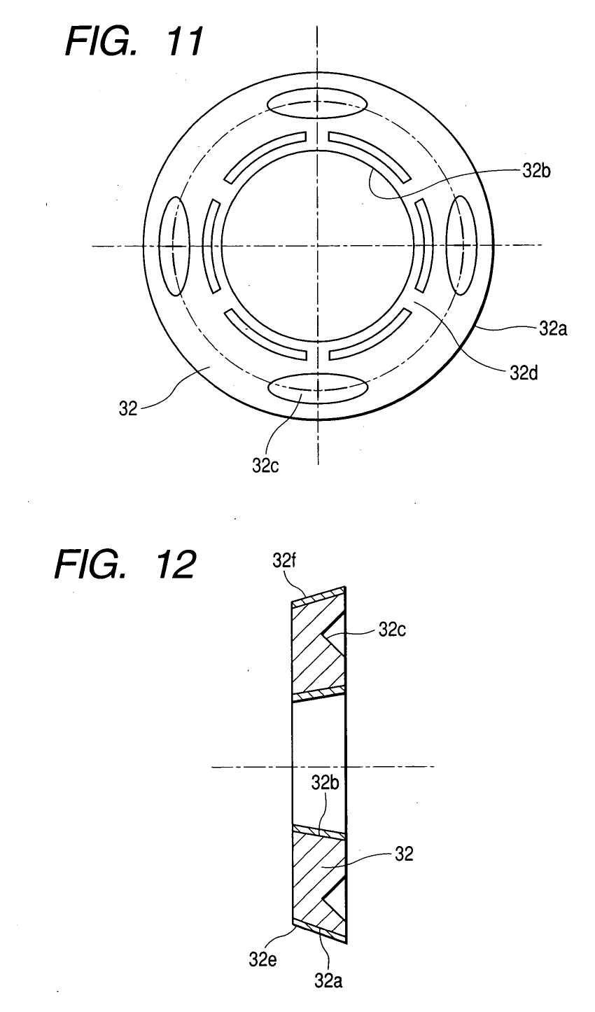

FIG. 12 is an illustration of a second embodiment of the present invention in which elastic members 32e and 32f, such as rubber, are stuck or adhered to inner and outer circumferential tapered portions of the movable cam plate 32. In this case, the connection/disconnection between the tapered portion 32b of the movable cam plate 32 and the outer circumferential portion 10a of the outer cam 10b or the tapered portion 9a of the housing 9 is made while they slides or slip. Therefore, the variation from a high reduction ratio to the reduction ratio 1 occurs gradually, which provides a characteristic similar to the variable speed change.

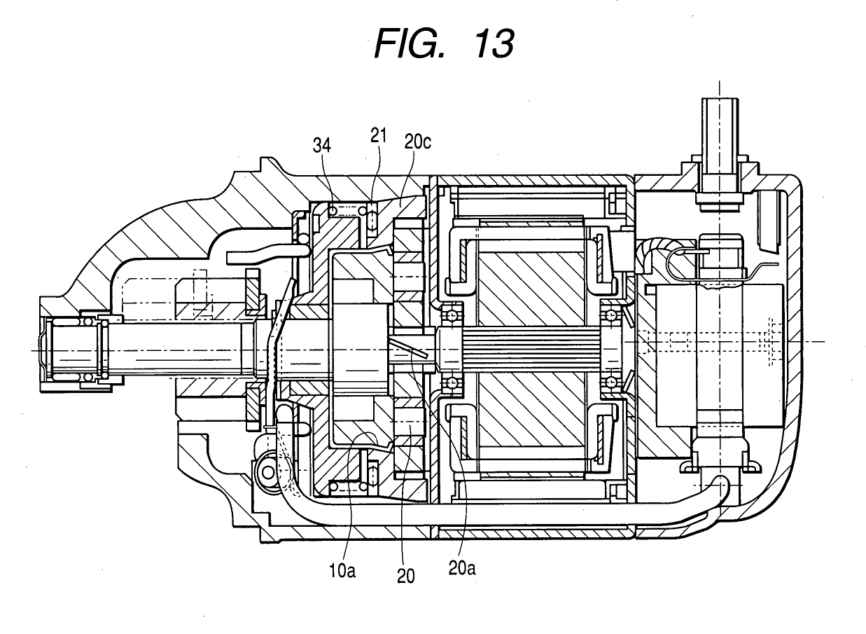

FIG. 13 is an illustration of a third embodiment of the present invention in which a helical gear is used to constitute the epicycle reduction section and the fixing and releasing of the internal gear 20c are made according to the magnitude of the force of the elastic member 34 through the use of an axial component of a torque of the helical gear.

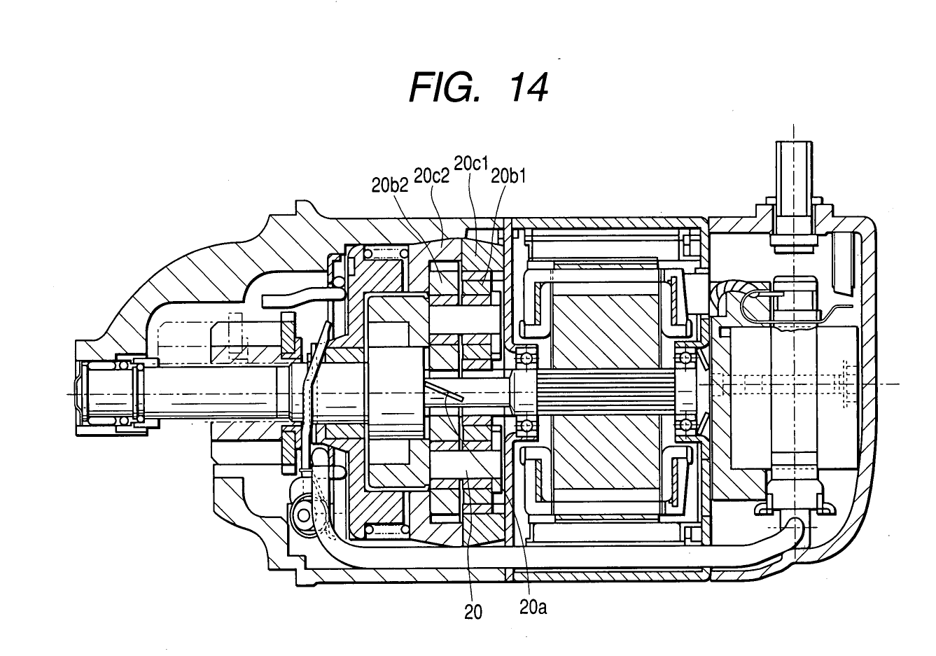

FIG. 14 is an illustration of a fourth embodiment of the present invention in which, in addition to the third embodiment, the epicycle reduction section is constructed in a two-stage fashion. Accordingly, the planetary gear includes planetary gears 20b1 and 20b2, and the internal gear includes internal gears 20c1 and 20c2. As a result, this epicycle reduction gear device has the number of teeth prescribed by the planetary gear 20b1 and the internal gear 20c1 and the number of teeth prescribed by the planetary gear 20b2 and the internal gear 20c2, that is, it provides two conditions different in number of teeth from each other. Thus, in the case of the switching from a high reduction ratio to a low reduction ratio, the reduction ratio can be set at appropriate values other than the reduction ratio 1, for example, a reduction ratio 9 and a reduction ratio 3.

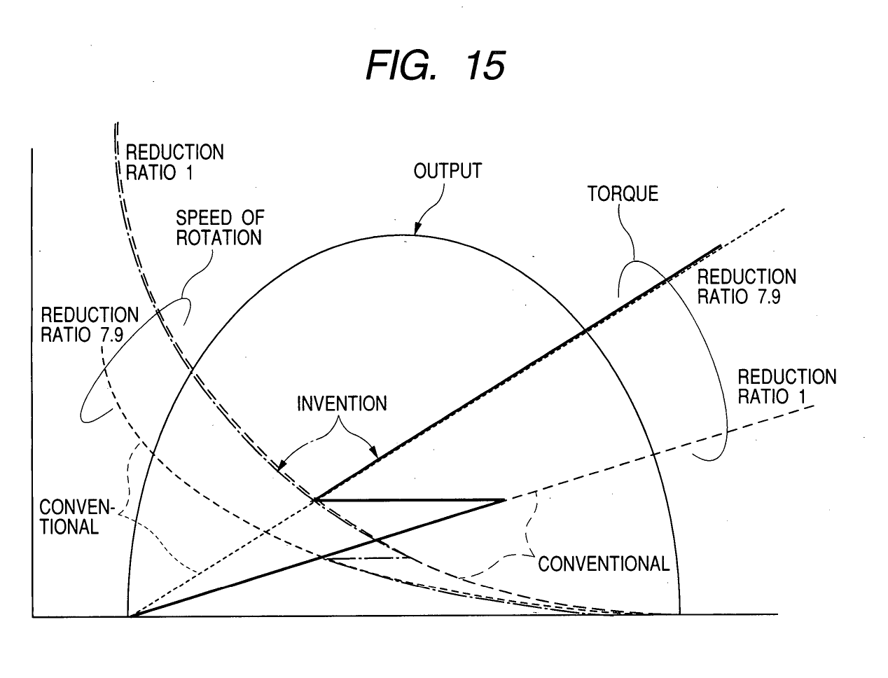

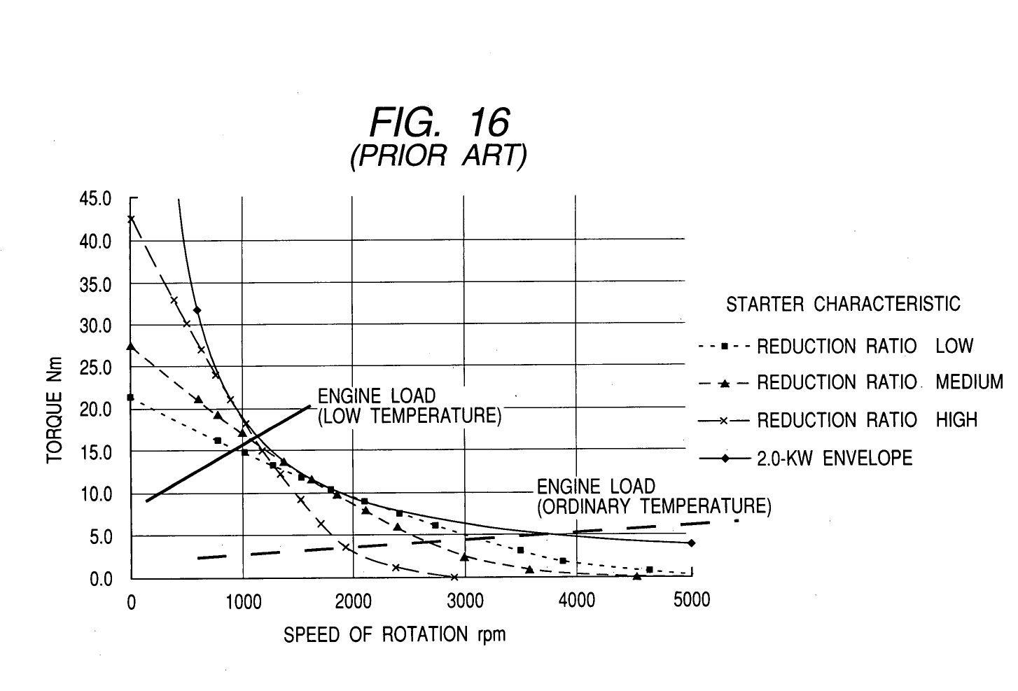

As described above, according to the present invention, the reduction ratio can be changed in a multi-stage fashion or a variable-speed fashion without increasing less cost and without increasing the body conformation. Moreover, since the reduction ratio is changed by sensing the performance itself of the motor of the starter even without taking external factors, such as engine and battery, into consideration, there is no need to consider the matching of the engine or the like, which is advantageous. Still moreover, there is no need to use a special sensor and a large-scale mechanism for varying the reduction ratio. Yet moreover, the adjustment of the load of the elastic member 34 can provide a more optimal torque or rotation curve (TN curve) at the starting of the engine. That is, as shown in FIG. 15, in a case in which the output curve is set to be equal to a conventional one, no only a high torque is obtainable during the first explosive combustion but also a high rotation is attainable at the completion of the explosive combustion, and even the speed change is feasible in the vicinity of the output peak. This can provide a TN curve superior to any conventional reduction ratio. Therefore, this eliminates the need for the consideration on the adaptability of the reduction ratio for each engine or battery and can achieve the standardization. In addition, since there is no need to use special parts, an increase in cost is avoidable. Still additionally, even in the case of the magnet type, a characteristic higher than that of the series type is obtainable and, also in this meaning, an increase in cost is avoidable. Accordingly, it is possible to cope easily with the recent environment problems.

It should be understood that the present invention is not limited to the above-described embodiments, and that it is intended to cover all changes and modifications of the embodiments of the invention herein which do not constitute departures from the spirit and scope of the invention.

What is claimed is:

1. A starter for an internal combustion engine, comprising a pinion engaging with a ring gear of said internal combustion engine, a motor for driving said pinion, a clutch provided between said pinion and said motor and an epicycle reduction gear device provided therebetween, with a reduction ratio of said epicycle reduction gear device being changed in a plural-stage fashion or in a variable speed fashion,
wherein a rotation of one of elements constituting a gear train of said epicycle reduction gear device is changed between a fixed condition and a released condition to change the reduction ratio.

2. The starter according to claim 1, wherein the change of the reduction ratio is made through the use of a planetary gear train including an internal gear pair, and it is changed by varying rotation of an internal gear serving as an element of said planetary gear train.

3. The starter according to claim 1, further comprising means for making a variation of rotation of said element on the basis of information on at least one of a torque of said motor and a speed of rotation thereof.

4. The starter according to claim 1, wherein, during cranking, an internal gear forming said element of said epicycle reduction gear device is fixed at a first explosive combustion of said internal combustion engine to maintain a high reduction ratio condition, and a speed of rotation of said internal gear is then made equal or substantially equal to a speed of rotation of an armature or a planetary gear shaft of said epicycle reduction gear device to produce a reduction ratio 1 condition or a low reduction ratio condition before starting said engine.

5. The starter according to claim 2, wherein said epicycle reduction gear device is composed of a sun gear provided on an armature shaft of said motor, a planetary gear engaging with said sun gear, said internal gear and a shaft of said planetary gear, with said shaft of said planetary gear being connected through a clutch to said pinion, and said internal gear is fixed at the beginning of cranking and a speed of rotation of said internal gear is then set at the same value as that of an armature of said motor or said planetary gear shaft to switch the reduction ratio in two stages.

6. The starter according to claim 2, wherein said epicycle reduction gear device is composed of a sun gear provided on an armature shaft of said motor, a planetary gear engaging with said sun gear, said internal gear and a shaft of said planetary gear, with said shaft of said planetary gear being connected through a clutch to said pinion, and said internal gear is fixed at the beginning of cranking and a speed of rotation of said internal gear is finally set at the same value as that of said armature or said planetary gear shaft and said internal gear is brought into sliding contact with said armature or said planetary gear shaft in a condition between the beginning of the cranking and the final value to gradually vary the speed of rotation of said internal gear for varying the reduction ratio in a variable-speed fashion.

7. The starter according to claim 5, wherein, during cranking, said internal gear is placed into a fixed condition at a first explosive combustion of said internal combustion engine to maintain a high reduction ratio state, and said internal gear is then brought into contact with said clutch to vary the rotation of said internal gear for changing the reduction ratio in a plural-stage fashion or in a variable speed fashion.

8. The starter according to claim 2, wherein, immediately after the staring of said engine, the reduction ratio is maintained at a high condition, and said internal gear is released from said fixed condition on the basis of information on a speed of rotation of a motor, a torque thereof, a current thereof or an output thereof at a maximum output of said motor to change the reduction ratio to a low reduction ratio.

9. The starter according to claim 2, wherein the fixing and releasing of said internal gear are made through a member which operates while sensing a reaction force of a torque of said motor at said internal gear.

10. A starter for an internal combustion engine, comprising a pinion provided to engage with a ring gear of said internal combustion engine and separate therefrom, a clutch provided between said pinion and a motor for driving said pinion, and an internal gear type epicycle reduction gear device provided therebetween, with said epicycle reduction gear device being composed of a sun gear provided on an armature shaft of said motor, a planetary gear engaging with said sun gear, an internal gear and a shaft of said planetary gear, with said shaft of said planetary gear being connected through said clutch to said pinion,
wherein said internal gear is fixed directly or indirectly to a body of said starter at the beginning of cranking to place a reduction ratio of said epicycle reduction gear device in a high reduction ratio condition and said internal gear is brought directly or indirectly into contact with said clutch at the latter half of the cranking so that a speed of rotation of said internal gear is set to be substantially equal to that of said planetary gear shaft to place the reduction ratio at 1 or in a low reduction ratio condition, with the switching of the reduction ratio being made by sensing a torque of said internal gear.

11. The starter according to claim 10, further comprising a cam mechanism including a fixed cam plate and a movable cam plate paired and coaxially disposed in opposed relation to each other so that one is unmovable in axial directions and the other is movable in said axial directions, and having a pair of cam grooves made in their opposed surfaces, a ball accommodated in said pair of cam grooves of both said cam plates to be rollable, and an elastic member made to elastically bias said movable cam plate 32 toward the fixed cam plate side,
in one of said cam grooves, a slope being formed so that a depth of said cam groove decreases in at least one of circumferential directions, while in the other cam groove, a slope being formed so that a depth of the other cam groove decreases in at least the other circumferential direction, and the depths at the deepest portions of both said cam grooves being set to be smaller in dimension than the radius of said ball and the depths at the shallowest portions of both said cam grooves being set to prevent said ball from breaking free therefrom, and
said movable cam plate being brought close to said fixed cam plate when said ball is placed at the deepest positions of both said cam grooves due to the relative rotation of both said cam plates while said movable cam plate being isolated from the fixed cam plate side when said ball is placed at the shallowest positions of both said cam grooves due to the relative rotation of both said cam plates, and
one of said fixed cam plate and said movable cam plate being put in common use as a portion of a side surface of said internal gear.

12. The starter according to claim 11, wherein, to bring said movable cam plate closer to said fixed cam plate side or to isolate it therefrom, fixing and releasing of said internal gear are made by a reaction force of a torque of said motor at said internal gear and a magnitude of a set load of said elastic member.

13. The starter according to claim 12, wherein said set load of said elastic member is set at a force equivalent to a torque corresponding to a maximum output current of said starter.
